(19) United States
(12) Patent Application Publication
(10) Pub. No.: US 2007/0246214 A1
(43) Pub. Date: Oct. 25, 2007

(54) Proppants made from filled polymers for use during oil and gas production and associated processes

(76) Inventors: Robert B. Fish JR., Parkersburg, WV (US); Steven A. Mestemacher, Parkersburg, WV (US); Wayne R. Fontaine, Belpre, OH (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/725,704

(22) Filed: Mar. 19, 2007

Related U.S. Application Data
(60) Provisional application No. 60/783,972, filed on Mar. 20, 2006.

(51) Int. Cl. E21B 43/267; C09K 8/80

(52) U.S. Cl. 166/280.2; 507/924

(57) ABSTRACT

Novel proppants useful in facilitating the hydraulic fracturing of subterranean formations are disclosed, made from filled polymers such as polyamides and polyesters. A process for the hydraulic fracturing of subterranean formations using filled polymeric proppants is disclosed.

### CROSS REFERENCE TO RELATED APPLICATIONS

This application claims the benefit of priority to U.S. Provisional Application No. 60/783,972, filed Mar. 20, 2006.

### FIELD OF THE INVENTION

The present invention relates to materials useful to facilitate the maintenance of cracks formed in the fracturing of subterranean formations in oil and gas production and methods for fracturing the formations. Polymeric proppants are incorporated into high pressure fluids to help create and maintain fractures in rock, contributing to increased well production in the oil and gas field.

### BACKGROUND OF THE INVENTION

Proppants are particulate material used in the hydraulic fracturing of subterranean formations, and they also function to keep the cracks open. Sand and small ceramic beads are suspended in the fracturing fluid and often used in hydraulic fracturing of oil and gas wells, and are one such variety of proppants. Hydraulic fracturing is accomplished by pumping fluid down a well under high pressure to create fractures in the surrounding rock as one of the common ways to increase production of a well. The proppants flow into the fractured cracks and extend outward from the wellbore to prop the fractures open. When the pumping pressure is ceased, the proppant materials remain in the cracks of the separated rock to form an open channel to allow the hydrocarbons to flow more easily to the surface. As oil and gas resources continue to deplete, there is more need for hydraulic fracturing. The proppant temperature resistance, hardness and resistance to deformation during exposure are important properties. High temperature capability is assumed to be a given, especially since the incumbent materials are sand and ceramic. The hardness and resistance to deformation are essential to support the burden of the rock, and have the strength to resist the stress. Fracturing may also be accomplished by the use of explosive charges and in such applications proppants may also be used.

There are a few major types of proppants. Resin coated sand (including a phenolic acid coating for stickiness) is used so that as the temperature increases, the coating gets soft and grains stick together. In this manner these proppants stay in the fracture rather than spitting back into the well-bore and plugging. In horizontal configurations the proppants are more susceptible to being permeable. A horizontal fracture is sideways, and establishes the flow path in the reservoir and the wellbore. A vertical fracture establishes flow between the layers of rock. The better the fracture the better the permeation of the fluids.

There are a variety of existing approaches and incumbent materials useful in enhancing oil and gas production from oil fields and pertaining to proppants. U.S. Pat. No. 6,772,838 claims methods and compositions for treating a well by using a modifying agent as an enhancement. U.S. Pat. No. 6,209,643 utilizes a tackifying compound and a treatment chemical to retard both the movement and the flowback of the particles. Flowback is the transport of particles back into the wellbore and is an undesirable condition. Particle flowback can cause wear on equipment, contamination of the hydrocarbon fluid, and also will not serve the intended purpose of keeping the flow channel open. U.S. Pat. No. 5,439,055 utilizes the addition of fibrous materials in a mixture with sand particulates to decrease flowback. U.S. Pat. No. 5,054,552 uses a breaker system for aqueous fluids containing xanthan gums. Breaking refers to intentionally lowering the viscosity of the fracturing fluid and thus allowing it to flow back and be removed from the well. However these approaches often represent considerable additional expense in the oil production and refinery process. Often they are only used in the last 5-25% of the proppant placement in an attempt to reduce cost. The expense is made more pronounced because these materials are themselves typically expensive and are used in high volume while being pumped into subterranean areas where their recovery and reuse is not plausible.

A problem not solved by the prior art is that the density of the proppant particles is high compared to the fracturing fluid. For example, while the density of a typical fracturing fluid is about 0.8 g/cc, the density of sand is about 2.65 g/cc. This will allow the proppant particles to settle too rapidly during the fracturing process. Commonly used fracturing fluids thus often have high viscosities in order to effectively suspend the high specific gravity proppants commonly used. A disadvantage to using high viscosity fluids is that they often do not efficiently penetrate small cracks.

Among materials commonly used as proppants are sand, ceramic beads, and walnut hulls. These materials, while possessing the strength desired for effective use as a proppant, also deteriorate into fines under the pressure that would be experienced underground. In addition, the proppants of the prior art do not possess resilience needed to press back against shifting subterranean pressures, as do the proppants of this invention.

It is an object of the present invention to provide a technical solution to problems such as the generation of fines, settling and flow, encountered in the oil and gas industry pertaining to the efficient and effective ability to extract hydrocarbon-containing fluids and gasses from cracks and fissures in subterranean material while using proppants. A feature of the present invention is the relatively low cost position of the basic materials that make up the proppants described herein. It is an advantage of the present invention to use these proppants in widely available high-pressure fluids, and without requiring retrofitting or modification of existing equipment in service in the fields. These and other objects, features and advantages of the present invention will become better understood upon having reference to the following description of the invention.

### BRIEF DESCRIPTION OF THE DRAWINGS

FIG. 1 is an illustration of proppant crush tester used to determine properties of the polymeric particles used in the present invention.

### SUMMARY OF THE INVENTION

There is disclosed and claimed herein proppants comprising about 25 to about 75 weight percent of at least one polymer and about 25 to about 75 weight percent of at least one filler, wherein the weight percentages are based on the total weight of the particles. Further disclosed and claimed herein is a process for the hydraulic fracturing of subterranean formations, comprising introducing a fluid in which is suspended polymeric particles comprising about 25 to about 75 percent of at least one polymer and about 25 to about 75 weight percent of at least one filler, wherein the weight percentages are based on the total weight of the particles, into an oil or gas well surrounded by rock such that fractures are created in the rock and some or all of the polymeric pellets flow into the fractures.

### DETAILED DESCRIPTION OF THE INVENTION

As used herein, the term “proppant” refers to a particulate material present in a fracture in a subterranean oil or gas well. The proppants of the present invention are polymeric particles comprising about 25 to about 75 percent of at least one polymer and about 25 to about 75 of at least one weight percent filler, wherein the weight percentages are based on the total weight of the particles. The polymer is preferably at least one thermoplastic polymer.

The proppants are typically no greater than about 0.125 inches in any direction and typically have particle sizes that are larger than about 100 mesh. The preferred particle sizes will be different for different oil and gas wells and fractures and will vary as a function of the geology and other factors understood by those skilled in the art. Typical particle sizes used are about 6 to about 12 mesh, 12 about to about 20 mesh, about 20 to about 40 mesh, etc.

When manufactured, the proppants will generally have the shape and properties desired for a particular application. Without intending to limit the generality of the foregoing, spherical, spheroidal, elliptical, and small right cylindrical shapes can be used in various applications.

As noted earlier, proppants form an essential part of the process for fracturing wells for the production of oil or natural gas. It is commonly known that the fracturing process involves hydraulically pumping a mixture of fracturing fluid (such as water or oil) with suspended proppants into underground rock formations under high pressure. The fracturing fluid can contain crosslinked gel or linear gel. Concentration can vary from 100 kg proppant per cubic meter of fluid to 1200 kg proppant per cubic meter of fluid. As such, it is vital for well performance that the proppants remain suspended and not separate from the fracturing fluid during the fracturing process. Separation is readily detected by pressure readings as the proppant settles out into the fracture, which then becomes blocked and the wellbore fills up with fluid and sand, thus shutting down the pumping. Using current practice, this is accomplished by increasing the viscosity of the fracturing fluid with gels and then relying on the fluid flow to keep the proppants suspended. A more desirable solution would be to use a very hard proppant with a specific gravity closer to that of the fracturing fluid so the settling rate of the proppants would be reduced or eliminated.

The polymer is preferably a thermoplastic polymer. Examples of suitable thermoplastic polymers include, but are not limited to, polyamides, polyacetals, polyesters (including aromatic polyester and aliphatic polyester), liquid crystalline polyesters, polyolefins (such as polyethylene and polypropylene), polycarbonates, acrylonitrile-butadiene-styrene polymers (ABS), poly(phenylene oxide)s, poly(phenylene sulfide)s, polysulphones, polyarylates, polyetheretherketones (PEEK), polyetherketoneketones (PEKK), polystyrenes, and syndiotactic polystyrenes.

Preferred thermoplastic polymers include polyamides and polyesters. The density of unfilled polyamide 6,6 is about 1.1 g/cc, while densities of typical fracturing fluid are often about 0.8 to 1 g/cc, providing the opportunity to fill the polymer with reinforcing materials without excluding it from consideration as a suitable proppant candidate.

Polyamides may be homopolymers, copolymers, terpolymers, or higher order polymers. Blends of two or more polyamides may be used. Suitable polyamides can be condensation products of dicarboxylic acids or their derivatives and diamines, and/or aminocarboxylic acids, and/or ring-opening polymerization products of lactams. Suitable dicarboxylic acids include, adipic acid, azelaic acid, sebacic acid, dodecanedioic acid, isophthalic acid and terephthalic acid. Suitable diamines include tetramethylenediamine, hexamethylenediamine, octamethylenediamine, nonamethylenediamine, dodecamethylenediamine, 2-methylpentamethylenediamine, 2-methyloctamethylenediamine, trimethylhexamethylenediamine, bis(p-aminocyclohexyl)methane, m-xylylenediamine, and p-xylylenediamine. A suitable aminocarboxylic acid is 11-aminododecanoic acid. Suitable lactams include caprolactam and laurolactam.

Preferred aliphatic polyamides include polyamide 6; polyamide 6,6; polyamide 4,6; polyamide 6,9; polyamide 6,10; polyamide 6,12; polyamide 10,10; polyamide 11; and polyamide 12. Preferred semi-aromatic polyamides include poly(m-xylylene adipamide) (polyamide MXD,6), poly(dodecamethylene terephthalamide) (polyamide 12,T), poly(decamethylene terephthalamide) (polyamide 10,T), poly(nonamethylene terephthalamide) (polyamide 9,T), the polyamide of hexamethylene terephthalamide and hexamethylene adipamide (polyamide 6,T/6,6); the polyamide of hexamethyleneterephthalamide and 2-methylpentamethyleneterephthalamide (polyamide 6,T/D,T); the polyamide of hexamethylene isophthalamide and hexamethylene adipamide (polyamide 6,l/6,6); the polyamide of hexamethylene terephthalamide, hexamethylene isophthalamide, and hexamethylene adipamide (polyamide 6,T/6,l/6,6) and copolymers and mixtures of these polymers.

Examples of suitable aliphatic polyamides include polyamide 6/6 copolymer; polyamide 6,6/6,8 copolymer; polyamide 6,6/6,10 copolymer; polyamide 6,6/6,12 copolymer; polyamide 6,6/10 copolymer; polyamide 6,6/12 copolymer; polyamide 6/6,8 copolymer; polyamide 6/6,10 copolymer; polyamide 6/6,12 copolymer; polyamide 6/10 copolymer; polyamide 6/12 copolymer; polyamide 6/6,6/6,10 terpolymer; polyamide 6/6,6/6,9 terpolymer; polyamide 6/6,6/11 terpolymer; polyamide 6/6,6/12 terpolymer; polyamide 6/6,10/11 terpolymer; polyamide 6/6,10/12 terpolymer; and polyamide 6/6,6/PACM (bis-p-{aminocyclohexyl} methane) terpolymer.

It is often desirable that the polymer selected be crystalline or semicrystalline so the pressures to which is it subjected (typically on the order of 5,000 psi or higher) will not cause them to be crushed. The filler should be capable of reinforcing the polymer, while also reducing the potential for crush as exemplified below. Both the polymer and filler(s) should be relatively stable in the presence of typical downhole chemical environments and at the temperatures and pressures encountered in the application. Polyamide and polyester resins are well known for their stability as engineering polymers under a variety of conditions. The stability requirements for a particular well depends on the temperature, pH, and pressure present and exposure time to these conditions that is required.

Both polyamide and polyester polymers are well known in the art, both as neat and in a filled state. Both polymers have long been sold with fiberglass or mineral reinforcement. Note, for example, MINLON® is a mineral-filled polyamide. Glass-reinforced polyester and polyamide have been sold under the RYNITE® and ZYTEL® trademarks, respectively. All three brands are commercially available from E. I. DuPont de Nemours & Co., Inc., Wilmington, DE. Polyamides are in general a preferred material for the instant proppants.

The proppants are formed by melt blending the fillers with the polymers. Any melt blending technique known in the art may be used. For example, the component materials may be mixed using a melt-mixer such as a single—or twin-screw extruder, blender, kneader, roller, Banbury mixer, etc.

The polymeric particles may be formed from the melt-blended composition by a cutting operation, such as underwater melt cutting or strand cutting. The required particle sizes could be obtained by grinding (cryogenic or not) polymeric compositions. Rounded particles can be formed by dropping rough-edged particles into a counter-current of hot gas (e.g., air or nitrogen), such that the edges melt and are smoothed. It is readily appreciated that these and other approaches are commonly used and understood among those having skill and expertise in this field. Further, other means of obtaining the particles could be utilized without departing from the spirit of this invention.

Preferred fillers for use in the present invention include sand, silica, quartz, silicon carbide, and aluminum oxide, staurolite (including staurolite sand), and wollastonite. Fillers may also include glass beads, glass powder, glass fibers, ceramics, clays (e.g., kaolin), and commercial grits. The fillers may be in a variety of forms, such as ground particles, flakes, needle-like particles, and the like. The size and form of the particles should be selected such that they may easily be incorporated into the polymeric carrier and allow for the formation of proppants having the desired sized.

The fillers preferably have a Mohs hardness of at least about 3, or more preferably of at least about 5, or yet more preferably of at least about 6, or still more preferably of at least about 7.

The fillers may optionally be pretreated with one or more compatibilizing and/or coupling agents that facilitate adhesion to or other compatibility with the polymer. Compatibilizing and/or coupling agents may also be added to the filler and polymer mixture prior to or during melt blending to form the proppants. The compatibilizing and/or coupling agents may be used in about 0.01 to about 1 weight percent when they are added prior to or during melt blending. Examples of coupling agents suitable for use with sand or glass are silane coupling agents such as gamma-aminopropyl triethoxysilane (silane A-1100).

Finally, as the proppants will be used in high volume and pumped into a subterranean area where recovery and reuse will not be possible, it is also desired to keep the materials cost minimized. Fortunately, polyamide and polyester polymers are well-known materials of construction and the candidate materials for use as fillers are relatively inexpensive.

A number of considerations are taken into account when selecting proppants appropriate to the intended use. It is often useful for there to be sufficient space between the proppant particles for the desired fluid to be able to easily flow between them. For example, so-called “Ottawa sand”, a rounded or spheroidal material, is commonly currently used as it has particles of such a size that there is a relatively large amount of space between the particles. In addition, the size of material may also be a consideration depending on depth of field applications. For example, big particles give more open space, but big particles are more easily crushed by “closure stress.” When particles are crushed, they can form very fine particles that decrease the permeability of oil or gas through the cracks. For shallow depths big round particles can be favored, while for deeper depths smaller round particles can be the material of choice. High temperatures are also an issue at deeper depth and polymeric materials having sufficient temperature resistant should be selected for such applications.

### EXAMPLES

In Examples 1-16, polymeric particles for use as proppants were manufactured by melt-blending polyamide 6,6 (Zytel® 101, supplied by E. I. du Pont de Nemours and Co.) with the fillers indicated in Table 1. The weight percentages given in the table are based on the total amount of polyamide 6,6 and filler. Comparative Example 1 is Zytel® 101. Melt-blending was carried out in a 57 Werner & Pfleiderer co-rotating twin screw extruder operating at a barrel temperature of about 270° C. and a die temperature of about 280° C. The extruder screw was rotating at 100 rpm. The polyamide 6,6 was fed into the first barrel section and the filler ingredient was fed into the sixth barrel section by use of a side feeder. Extrusion was carried out with a port under vacuum. The total extruder feed rate was 100 pounds per hour. The resulting strand was quenched in water, cut into pellets using a Conair Model 206 pelletizer, and splurged with nitrogen until cool. As a small particle size was desired, the strand cutter speed was increased to produce small particles. The maximum pelletizer speed, i.e. the speed of the rotation of the pull roll and cutter blade rotation, was empirically determined as being the maximum speed that could be used without strand breakage.

The following fillers were used in the examples:

Glass fibers are PPG35400, supplied by PPG.
Glass beads were supplied by Flex-O-Lite Inc., Fenton, Mo.
Refractory oxide was 120 mesh and supplied by Saint-Gobain Industrial Ceramics, Worcester, Mass.
Talc was Talcron® MP 10-52 supplied by Bartletts Minerals, Inc., Dillon, Mont.
Kaolin was Translink® 445 supplied by Engelhard Corp., Iselin, N.J.
Silicon carbide was 180 grit and supplied by Agsco Corp, Wheeling, Ill.
Sand was supplied by U.S. Silica Co., Berkeley Springs, W.Va.

The average pellet weight was calculated by counting out 100 pellets selected at random and weighing them. The resulting data would represent the average weight of 100 pellets. The results are show in Table 1 under the heading of “pellet weight.” Lower pellet weights are more desirable.

Polymeric Particle Crush Testing

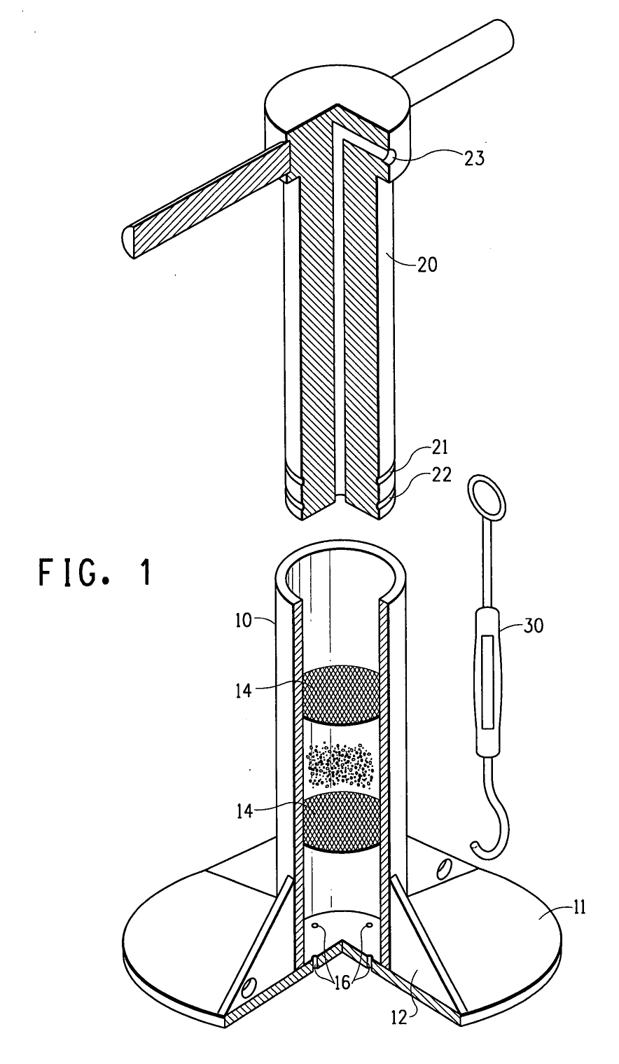

Polymeric particle crush testing was based on the proppant crush test described in Section 8.1 of API Recommended Practice 60 (Second Edition, December 1995). The particles for use as proppants were tested using the proppant tester illustrated in FIG. 1. The tester comprises a cylinder 10 having a mating plunger 20. A plate 11 is affixed to the bottom of cylinder 10 and supporting members 12 are included for mechanical strength. Cylinder 10 is made from 2-inch schedule 80 304 stainless steel pipe. Plate 11 has 4 0.25 inch diameter holes 16 drilled into plate 11 to allow water to drain from the cylinder Plunger 20 has grooves 21 and 22 for installation of sealing o-ring gaskets. A ¼-inch diameter hole 23 in the plunger for water addition extends from the top of the plunger to the bottom. Tubing was attached to the plunger to provide connection of domestic water supply into hole 23. The connection was also equipped with a pressure gauge to monitor water pressure. To provide for distribution and collection of water, five 30-mesh stainless steel screens 14 were placed in the bottom of cylinder 10. The screens were cut to be just smaller than the inside diameter of cylinder 10.

During testing, 400 ml of polymeric particles were placed in cylinder 10 on top of the screens. Five screens 16 that are similar to screens 14 were placed on top of the proppants and plunger 20 was inserted into cylinder 10 until it contacted the screens. The assembly was then placed in a hydraulic press. For this particular test, a Dake “H-frame” Hydraulic Press Model 50B was used. This equipment is available commercially from Dake, a Division of JSJ Corporation, Grand Haven, Mich. The pressure of the press was gradually increased to 10 tons. This corresponded to a pressure of 5620 psi. A turnbuckle assembly 30 was used to retain plunger 20, and therefore the polymeric particles, in their compressed state following their removal from the hydraulic press.

The height of the polymeric particles in cylinder 10 was measured before and after compression. The compacted volume percentage was calculated by dividing the height after compression by the height before compression and multiplying by 100 and is given is given in Table 1 under the heading of “compacted volume.” Higher compacted volume percentages are more desirable. No appreciable amount of fines were generated for any of the examples or the comparative example during compression.

Following compression, the entire assembly was removed from the press and connected to the water supply. Using the water connection and controlling valve, the water pressure was gradually increased to full flow and the flow rate of water through the polymeric particle bed was measured by noting the amount of time in seconds required for 1,000 mL of water to pass through the bed. An average of three measurements is reported in Table 1 under the heading of “average flow time.” Lower flow times are more desirable. The assembly was then disassembled by removing the plunger and cleaned of any residue before the next test.

TABLE 1

| | Poly- | | | | Com- | Average |
|---|---|---|---|---|---|---|
| | amide | | Weight | Pellet | pacted | flow |
| | 6,6 | | percent | weight | volume | time |
| | (wt. %) | Filler | filler | (g) | (%) | (sec) |
| Ex. 1 | 65 | Glass fibers | 35 | 0.88 | 59 | 23.8 |
| Ex. 2 | 55 | Glass fibers | 45 | 0.92 | 54 | 24.4 |
| Ex. 3 | 45 | Glass fibers | 55 | 1.09 | 38 | 66.8 |
| Ex. 4 | 65 | Glass beads | 35 | 1.29 | 69 | 22.8 |
| Ex. 5 | 55 | Glass beads | 45 | 1.53 | 66 | 24.2 |
| Ex. 6 | 45 | Glass beads | 55 | 2.44 | 62 | 23.7 |
| Ex. 7 | 65 | Refractory | 35 | 1.70 | 71 | 22.1 |
| | | oxide | | | | |
| Ex. 8 | 55 | Refractory | 45 | 1.73 | 67 | 23.1 |
| | | oxide | | | | |
| Ex. 9 | 65 | Talc | 35 | 1.51 | 67 | 23.9 |
| Ex. 10 | 65 | Kaolin | 35 | 1.44 | 78 | 22.4 |
| Ex. 11 | 65 | Silicon carbide | 35 | 1.66 | 72 | 21.9 |
| Ex. 12 | 55 | Silicon carbide | 45 | 1.70 | 70 | 22.4 |
| Ex. 13 | 45 | Silicon carbide | 55 | 1.70 | 62 | 23.7 |
| Ex. 14 | 65 | Sand (200 | 35 | 1.60 | 75 | 22.5 |
| | | mesh) | | | | |
| Ex. 15 | 55 | Sand (200 | 45 | 1.19 | 75 | 23.1 |
| | | mesh) | | | | |
| Ex. 16 | 65 | Sand (325 | 35 | 1.56 | 77 | 23.6 |
| | | mesh) | | | | |
| Comp. | 100 | — | 0 | — | 70 | 25.4 |
| Ex. 1 | | | | | | |

1. A process for the hydraulic fracturing of subterranean formations, comprising introducing a fluid in which is suspended polymeric particles comprising about 25 to about 75 weight percent of at least one polymer and about 25 to about 75 weight percent of at least one filler, wherein the weight percentages are based on the total weight of the particles, into an oil or gas well surrounded by rock such that fractures are created in the rock and some or all of the polymeric pellets flow into the fractures.

2. The process of claim 1, wherein the polymer is one or more polyamide and/or polyester.

3. The process of claim 1, wherein the filler is one or more of glass fibers, glass beads, glass powders, silica, quartz, and ceramics.

4. The process of claim 1, wherein the filler is one or more of sand, silicon carbide, staurolite, wollastonite, and aluminum oxide.

5. The process of claim 3, wherein the polymeric particles further comprise about 0.01 to about 1 weight percent of a coupling agent.

6. The process of claim 5, wherein the coupling agent is gamma-aminopropyltriethoxysilane.

7. The process of claim 1, wherein the filler has a Mohs hardness of at least about 3.

8. The process of claim 7, wherein the filler has a Mohs hardness of at least about 5.

9. Proppants comprising polymeric particles comprising about 25 to about 75 weight percent of at least one polymer and about 25 to about 75 weight percent of at least one filler, wherein the weight percentages are based on the total weight of the particles.

10. The proppants of claim 9, wherein the polymer is one or more polyamide and/or polyester.

11. The proppants of claim 9, wherein the filler is one or more of glass fibers, glass beads, glass powders, silica, quartz, and ceramics.

12. The proppants of claim 9, wherein the filler is one or more of sand, silicon carbide, staurolite, wollastonite, and aluminum oxide.

13. The proppants of claim 9, wherein the filler has a Mohs hardness of at least about 3.

14. The proppants of claim 13, wherein the filler has a Mohs hardness of at least about 5.

15. The proppants of claim 11, wherein the polymeric particles further comprise about 0.01 to about 1 weight percent of a coupling agent.

16. The proppants of claim 15, wherein the coupling agent is gamma-aminopropyltriethoxysilane.
